(19) United States
(12) Patent Application Publication
(10) Pub. No.: US 2013/0136043 A1
(43) Pub. Date: May 30, 2013

(54) METHOD FOR INTELLIGENT COMMUNICATING MANAGEMENT OF ELECTRONIC SHELF LABEL SYSTEM

(71) Applicant: Samsung Electro-Mechanics Co., Ltd., Suwon (KR)

(72) Inventors: Su Jong KIM, Suwon (KR); Sung Eon LEE, Suwon (KR); Jae Chan LEE, Hwaseong (KR); Jung Hwan PARK, Suwon (KR); Jeong Su SEO, Suwon (KR); Hyun Hak KIM, Osan (KR)

(73) Assignee: SAMSUNG ELECTRO-MECHANICS CO., LTD., Suwon (KR)

(21) Appl. No.: 13/683,023

(22) Filed: Nov. 21, 2012

(30) Foreign Application Priority Data
Nov. 24, 2011 (KR) 10-2011-0123688

(51) Int. Cl. H04B 7/24

(52) U.S. Cl. CPC H04B 7/24
USPC 370/310

(57) ABSTRACT

Disclosed herein is a method for intelligent communicating management of an ESL system, in wireless communication performed between first communication terminal equipment and second communication terminal equipment included in the electronic shelf label system, in which when the wireless communication is performed to the second communication terminal equipment from the first communication terminal equipment, a transmission packet including a state field indicating state information of the first communication terminal equipment is transmitted to the second communication terminal equipment.

### CROSS REFERENCE(S) TO RELATED APPLICATIONS

This application claims the benefit under 35 U.S.C. Section 119 of Korean Patent Application Serial No. 10-2011-0123688, entitled “Method for Intelligent Communicating Management of Electronic Shelf Label System” filed on Nov. 24, 2011, which is hereby incorporated by reference in its entirety into this application.

### BACKGROUND OF THE INVENTION

1. Technical Field

The present invention relates to a management method of an electronic shelf label (ESL) system, and more particularly, to a method for intelligent communicating management of an electronic shelf label system that manages state information of communication terminal equipment configuring the electronic shelf label (ESL) system.

2. Description of the Related Art

In general, a scheme of attaching paper printed with a price to a shelf on which products are displayed is adopted in order to display the prices of the products in a large-sized or medium/small-sized store, but this scheme has a difficulty in which paper is printed with the price, which should be attached to the shelf on which the products are displayed.

An electronic shelf label system (hereinafter, referred to as an ESL system) proposed in order to solve the problem displays price information of the product by using an ESL tag and further, additionally displays various promotion information including a price per unit, a sale price, a normal price, the display of a product display location, point information, display quantities, and the like to assist product purchasing and store operation.

FIG. 1 is a configuration diagram illustrating a configuration of an ESL system in the related art.

The ESL system includes an ESL server 100, a point of sale (POS) management system 102, a plurality of gateways 104, 106, and 110, a coordinator 108, and a plurality of ESL tags T1 to Tn, T1 to Tm, T1 to To, and T1 to Tp.

The POS system is a management system that receives distribution information including items, prices, quantities, and the like as well as a sale in a store in a distributor to analyze and utilize the received distribution information.

The ESL server generally manages the ESL system in link with the POS device.

The plurality of gateways 104, 106, and 110 enable a large number of ESL tags T1 to Tn, T1 to Tm, and T1 to Tp and the ESL server 100 to communicate with each other by extending a network coverage.

The coordinator 108 enables a plurality of ESL tags T1 to To and the ESL server 100 to communicate with each other by a Zigbee communication network.

The plurality of ESL tags T1 to Tn, T1 to Tm, T1 to To, and T1 to Tp performs wireless communication with the plurality of gateways 104, 106, and 110, and the coordinator 108, and is connected with the ESL server 100 through the plurality of gateways 104, 106, and 110, and the coordinator 108. The ESL server 100 manages display information associated with the plurality of ESL tags T1 to Tn, T1 to Tm, T1 to To, and T1 to Tp.

As such, in the ESL system as a system that automates the product information, a large number of ESL tags constitute a wireless network to perform wireless communication with the ESL server through a centralized gateway. A malfunction of communication equipment which occurs in a wireless communication environment may exert a band influence on the entire ESL system.

Accordingly, in order to prevent a negative influence from being exerted and stably operate the ESL system by improving the reliability of wireless communication equipment, it is important to continuously monitor the wireless communication equipment included in the ESL system.

### SUMMARY OF THE INVENTION

An object of the present invention is to provide a method for intelligent communicating management of an ESL system that transmits a transmission packet including a state field indicating state information of communication terminal equipment to second communication terminal equipment.

According to an exemplary embodiment of the present invention, there is provided a method for intelligent communicating management of an ESL system, in wireless communication performed between first communication terminal equipment and second communication terminal equipment included in the electronic shelf label system, in which when the wireless communication is performed to the second communication terminal equipment from the first communication terminal equipment, a transmission packet including a state field indicating state information of the first communication terminal equipment is transmitted to the second communication terminal equipment.

In this case, the state field may include at least one of booting state information, operational state information, communication state information, wireless channel quality state information, and battery state information of the first communication terminal equipment.

The first communication terminal equipment may be configured by an electronic shelf label tag, and the second communication terminal equipment may be configured by a gateway or a coordinator.

When the second communication terminal equipment receives the transmission packet, the second communication terminal equipment may store the state information of the first communication terminal equipment in a management table and thereafter, transmit a completion packet to the first communication terminal equipment.

Meanwhile, the second communication terminal equipment may transmit the state information of the first communication terminal equipment stored in the management table to a final manager simultaneously with transmitting the completion packet.

### BRIEF DESCRIPTION OF THE DRAWINGS

FIG. 1 is a configuration diagram illustrating a configuration of an ESL system in the related art;

FIG. 2 is a flowchart of a method for intelligent communicating management of an ESL system performed between first communication terminal equipment and second communication terminal equipment in the method for intelligent communicating management of an ESL system according to an exemplary embodiment of the present invention; and

FIG. 3 is a diagram illustrating the structure of a transmission packet transmitted to the second communication terminal equipment from the first communication terminal equipment.

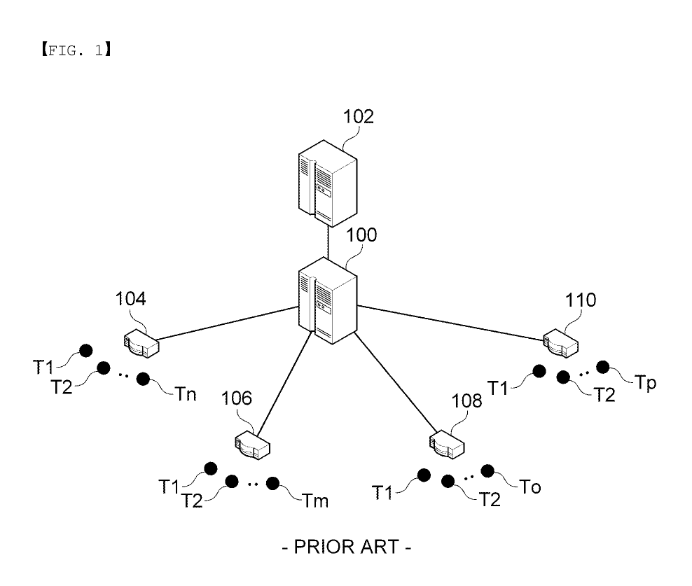

### DESCRIPTION OF THE PREFERRED EMBODIMENTS

Various advantages and features of the present invention and methods accomplishing thereof will become apparent from the following description of embodiments with reference to the accompanying drawings. However, the present invention may be modified in many different forms and it should not be limited to the embodiments set forth herein. These embodiments may be provided so that this disclosure will be thorough and complete, and will fully convey the scope of the invention to those skilled in the art. Like reference numerals throughout the description denote like elements.

Terms used in the present specification are for explaining the embodiments rather than limiting the present invention. Unless explicitly described to the contrary, a singular form includes a plural form in the present specification. The word “comprise” and variations such as “comprises” or “comprising,” will be understood to imply the inclusion of stated constituents, steps, operations and/or elements but not the exclusion of any other constituents, steps, operations and/or elements.

Hereinafter, a configuration and an operational effect of the present invention will be described in more detail with reference to the accompanying drawings.

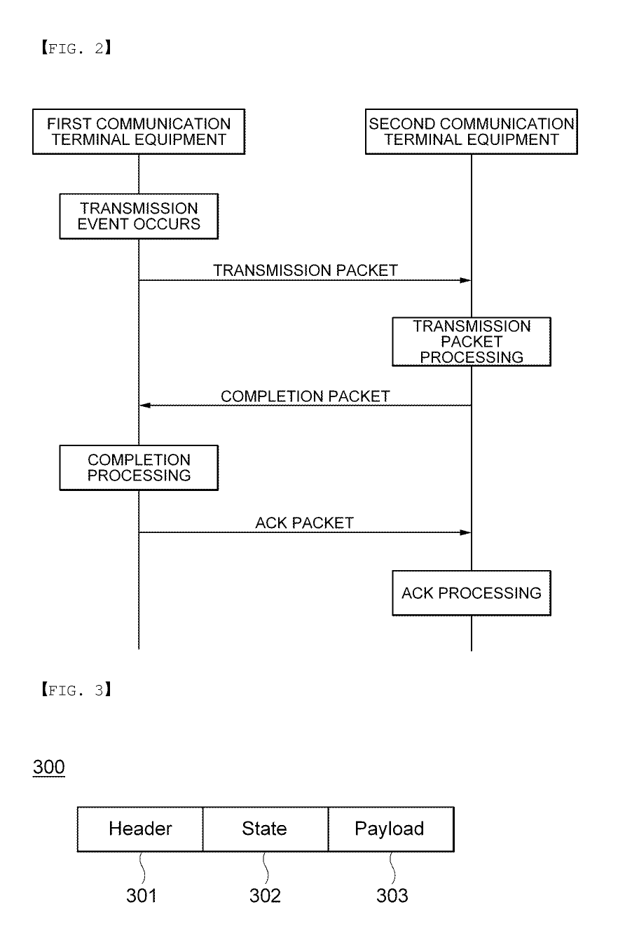

FIG. 2 is a flowchart of a method for intelligent communicating management of an ESL system performed between first communication terminal equipment and second communication terminal equipment in the method for intelligent communicating management of an ESL system according to an exemplary embodiment of the present invention.

Referring to FIG. 2, in the method for intelligent communicating management of an ESL system according to the exemplary embodiment of the present invention, in wireless communication achieved between the first communication terminal equipment and the second communication terminal equipment included in the electronic shelf label system, when the wireless communication is performed to the second communication terminal equipment from the first communication terminal equipment, a transmission packet including a stated field indicating state information of the first communication terminal equipment may be transmitted to the second communication terminal equipment.

Herein, the first communication terminal equipment as communication terminal equipment positioned on a lower layer of the second communication terminal equipment may be configured by for example, an ESL tag in the ESL system and the second communication terminal equipment as communication terminal equipment positioned on an upper layer of the first communication terminal equipment may be configured by for example, a gateway or a coordinator.

The wireless communication performed between the first communication terminal equipment and the second communication terminal equipment will be described below in detail. First, before the transmission packet is transmitted from the first communication terminal equipment to the second communication terminal equipment, a transmission event occurs for the wireless communication with the second communication terminal equipment in the first communication terminal equipment.

Since the ESL tag maintains a sleep mode in order to minimize power consumption, the transmission event having a predetermined cycle occurs depending on a predetermined program so as to perform the wireless communication with a router or the coordinator to switch the ESL tag to a wake-up mode.

When the transmission event occurs in the first communication terminal equipment, the first communication terminal equipment performs the wireless communication with the second communication terminal equipment and in this case, the first communication terminal equipment transmits the transmission packet including the state field indicating the state information of the first communication terminal equipment to the second communication terminal equipment.

FIG. 3 is a diagram illustrating the structure of a transmission packet 300 transmitted to the second communication terminal equipment from the first communication terminal equipment. The transmission packet 300 transmitted from the first communication terminal equipment will be described below in more detail. The transmission packet 300 may be constituted by a header 301 field, a state 302 field, and a payload 303 field.

The header 301 field includes packet identifier information to determine the length of a packet and the type of packet data, and the payload 303 field may generally include various data information including a product price per unit, a sale price, a normal price, the display of a product display location, point information, display quantities, and the like, in the ESL system, as a region storing message data.

The state 302 field may include at least one of booting state information, operational state information, communication state information, wireless channel quality state information, and battery state information of the first communication terminal equipment.

The booting state information means booting state information of the communication terminal equipment, for example, information on the maximum, minimum, average number of times required for booting, and the operational state information means a transition state, a memory state, state information of other various hardware sensors, and the like of a central processing unit (CPU) incorporated in the communication terminal equipment. The communication state information means the number of transmission/reception times and the number of retransmission times between the first communication terminal equipment and the second communication terminal equipment, the wireless channel quality state information means a received signal strength of indication (RSSI), a signal quality estimate (SQE), and the like, and the battery state information means the remaining amount of a battery, a battery usable time, and the like.

When the transmission packet 300 is transmitted from the first communication terminal equipment and received by the second communication terminal equipment, the second communication terminal equipment stores the state information of the first communication terminal equipment in a management table and transmits a completion packet to the first communication terminal equipment.

When the completion packet is transmitted, the first communication terminal equipment processes the transmitted completion packet and thereafter, transmits the ACK packet meaning that the completion packet is received and the second communication terminal equipment processes the transmitted ACK packet.

Meanwhile, the second communication terminal equipment transmits the management table to a final manager simultaneously with transmitting the completion packet. Herein, the final manager means a person who manages the product through the ESL server, and manages and monitors the entire ESL system.

As a result, the final manager may determine the state of the first communication terminal equipment by referring to the state information of the management table and perform appropriate processing of the communication terminal equipments by using the determined information.

As such, according to the method for intelligent communicating management of the ESL system in the ESL system according to the exemplary embodiment of the present invention, as the transmission packet 300 including the state information of the wireless communication equipment positioned relatively in the lower layer is transmitted to the wireless communication equipment positioned relatively in the upper layer, the internal state information of the wireless communication equipment in the electronic shelf label system positioned remotely can be internally managed and the final manager can provide against the malfunction of the electronic shelf label system.

As set forth above, according to the method for intelligent communicating management of the ESL system of the exemplary embodiments of the present invention, internal state information of the wireless communication equipment of the electronic shelf label system positioned remotely can be internally managed, and the manager can cope with the malfunction of the wireless communication equipment which may occur in the electronic shelf label system in real time. As a result, it is possible to generally improve the availability and the reliability of the electronic shelf label system.

The present invention has been described in connection with what is presently considered to be practical exemplary embodiments. Although the exemplary embodiments of the present invention have been described, the present invention may be also used in various other combinations, modifications and environments. In other words, the present invention may be changed or modified within the range of concept of the invention disclosed in the specification, the range equivalent to the disclosure and/or the range of the technology or knowledge in the field to which the present invention pertains. The exemplary embodiments described above have been provided to explain the best state in carrying out the present invention. Therefore, they may be carried out in other states known to the field to which the present invention pertains in using other inventions such as the present invention and also be modified in various forms required in specific application fields and usages of the invention. Therefore, it is to be understood that the invention is not limited to the disclosed embodiments. It is to be understood that other embodiments are also included within the spirit and scope of the appended claims.

What is claimed is:

1. A method for intelligent communicating management of an ESL system in wireless communication performed between first communication terminal equipment and second communication terminal equipment included in the electronic shelf label system, wherein:
when the wireless communication is performed from the first communication terminal equipment to the second communication terminal equipment, a transmission packet including a state field indicating state information of the first communication terminal equipment is transmitted to the second communication terminal equipment.

2. The method for intelligent communicating management of an ESL system according to claim 1, wherein:
the state field includes at least one of booting state information, operational state information, communication state information, wireless channel quality state information, and battery state information of the first communication terminal equipment.

3. The method for intelligent communicating management of an ESL system according to claim 1, wherein:
the first communication terminal equipment is configured by an electronic shelf label tag, and
the second communication terminal equipment is configured by a gateway or a coordinator.

4. The method for intelligent communicating management of an ESL system according to claim 1, wherein:
when the second communication terminal equipment receives the transmission packet, the second communication terminal equipment stores the state information of the first communication terminal equipment in a management table and thereafter, transmits a completion packet to the first communication terminal equipment.

5. The method for intelligent communicating management of an ESL system according to claim 4, wherein:
the second communication terminal equipment transmits the state information of the first communication terminal equipment stored in the management table to a final manager simultaneously with transmitting the completion packet.
